(19) United States
(12) Patent Application Publication
(10) Pub. No.: US 2018/0368624 A1
(43) Pub. Date: Dec. 27, 2018

(54) Heated Scoop Assembly

(71) Applicant: John Bailey, Lakeland, FL (US)

(72) Inventor: John Bailey, Lakeland, FL (US)

(21) Appl. No.: 15/634,867

(22) Filed: Jun. 27, 2017

(51) Int. Cl. A47J 43/28; A23G 9/28

(52) U.S. Cl. CPC A47J 43/282; A23G 9/28

(57) ABSTRACT

A heated scoop assembly for enhancing scooping ice cream includes a scooper that is selectively manipulated thereby facilitating the scooper to scoop ice cream. A heating unit is coupled to the scooper such that the heating unit is in thermal communication with the scooper. The heating unit is selectively turned on to heat the scooper. In this way the scooper melts the ice cream when the ice cream is scooped thereby enhancing scooping the ice cream.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### Background of the Invention

### (1) Field of the Invention

### (2) Description of Related Art Including Information Disclosed Under 37 CFR 1.97 and 1.98

The disclosure and prior art relates to scoop devices and more particularly pertains to a new scoop device for enhancing scooping ice cream.

### BRIEF SUMMARY OF THE INVENTION

An embodiment of the disclosure meets the needs presented above by generally comprising a scooper that is selectively manipulated thereby facilitating the scooper to scoop ice cream. A heating unit is coupled to the scooper such that the heating unit is in thermal communication with the scooper. The heating unit is selectively turned on to heat the scooper. In this way the scooper melts the ice cream when the ice cream is scooped thereby enhancing scooping the ice cream.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a heated scoop assembly according to an embodiment of the disclosure.

FIG. 2 is a back view of an embodiment of the disclosure.

FIG. 3 is an exploded perspective view of an embodiment of the disclosure.

FIG. 4 is a bottom view of an embodiment of the disclosure.

FIG. 5 is a cross sectional view taken along line 5-5 of FIG. 4 of an embodiment of the disclosure.

### DETAILED DESCRIPTION OF THE INVENTION

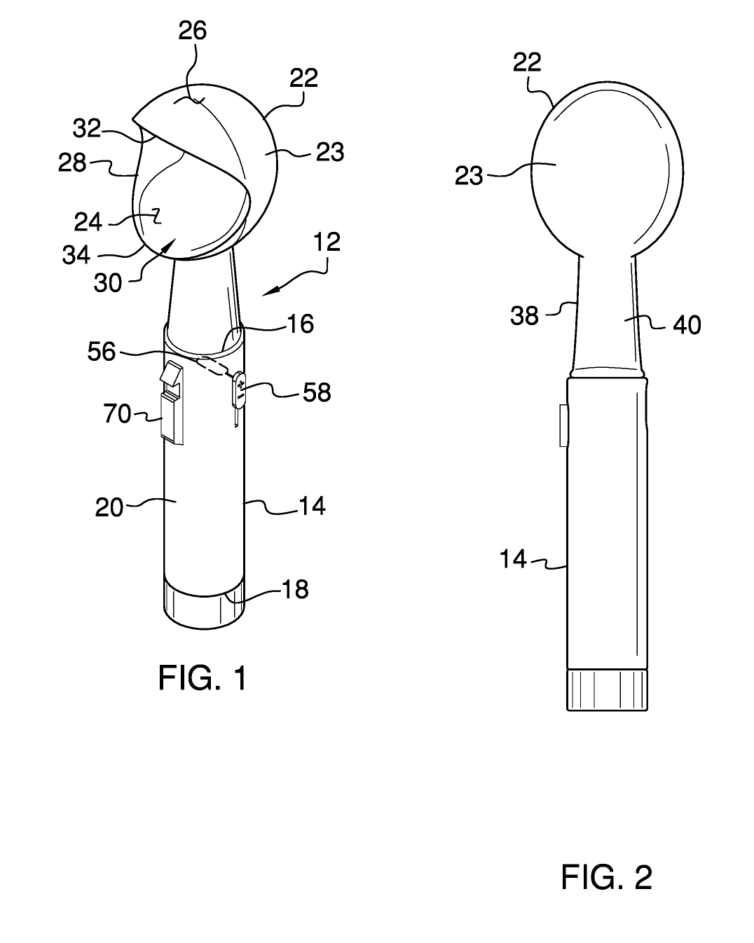

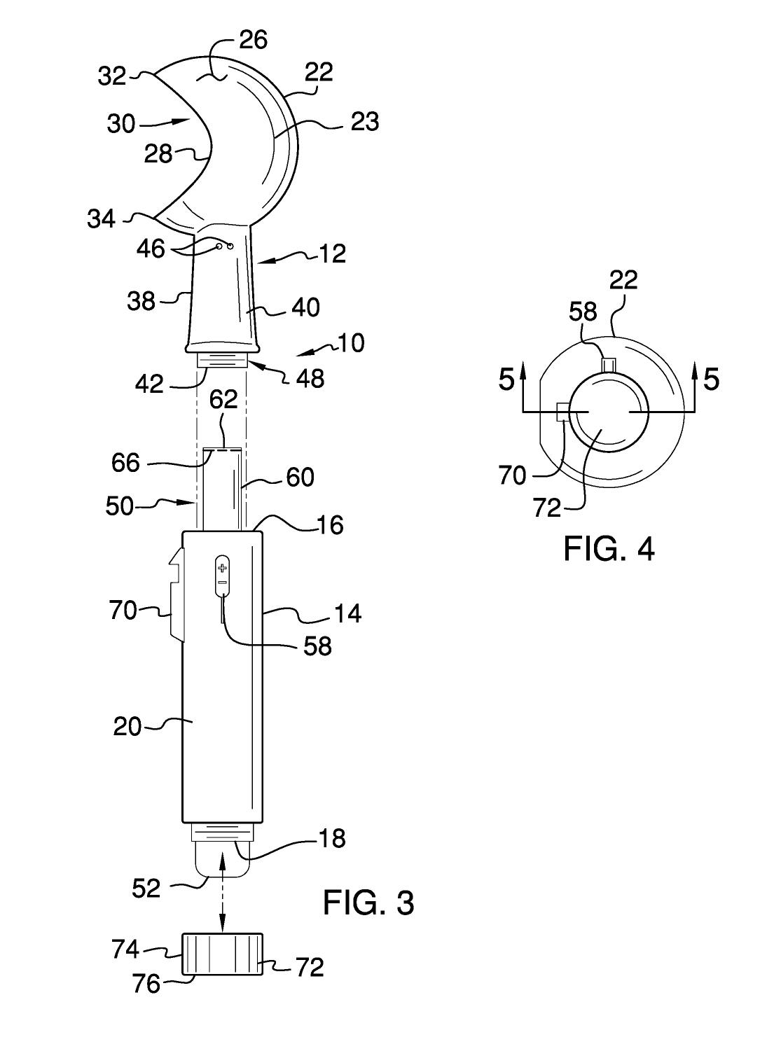

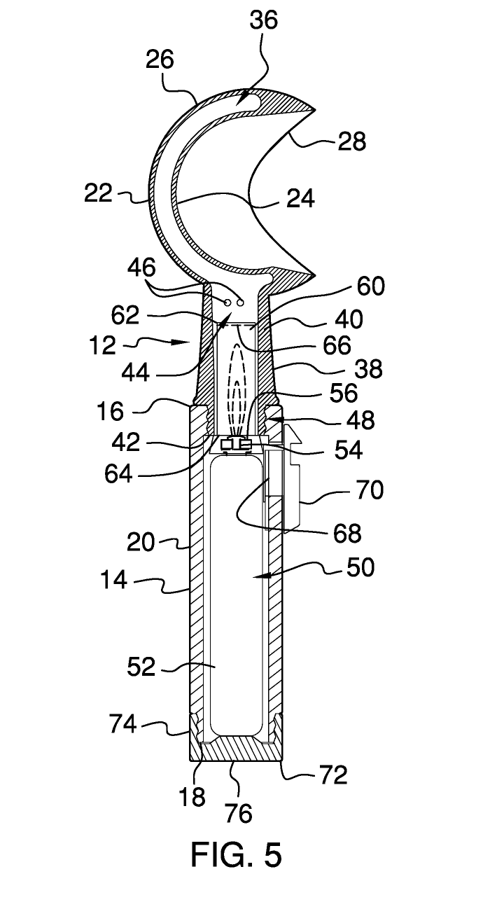

With reference now to the drawings, and in particular to FIGS. 1 through 5 thereof, a new scoop device embodying the principles and concepts of an embodiment of the disclosure and generally designated by the reference numeral 10 will be described.

As best illustrated in FIGS. 1 through 5, the heated scoop assembly 10 generally comprises a scooper 12 that is selectively manipulated to scoop ice cream. The scooper 12 includes a handle 14 that has a first end 16, a second end 18 and an outer wall 20 extending therebetween. Each of the first 16 and second 18 ends is open and the handle 14 is substantially hollow. Additionally, the outer wall 20 is threaded adjacent to the second end 18.

The scooper 12 includes a scoop 22 that has an outer wall 23. The outer wall 23 of the scoop 22 has a first surface 24, a second surface 26 and a peripheral edge 28 extending therebetween. Moreover, each of the first 24 and second 26 surfaces is concavely arcuate such that the scoop 22 has a spherical shape. The peripheral edge 28 is oriented to define an opening 30 into the spherical shape and the peripheral edge 28 urges the ice cream into the scoop 22 when the scooper 12 is manipulated. The peripheral edge 28 has a top section 32 and a bottom section 34 and the peripheral edge 28 curves rearwardly between the top 32 and bottom 34 sections. Thus, the opening 30 defines a hyperbolic parabloid. The scoop 22 has a first chamber 36 between the first surface 24 and the second surface 26 and the scoop 22 is comprised of a thermally conductive material.

A shaft 38 extends downwardly from the second surface 26 of the scoop 22 and the shaft 38 has an outside wall 40 and a distal end 42 with respect to the scoop 22. The distal end 42 has a second chamber 44 extending toward the scoop 22. Moreover, the second chamber 44 intersects the first chamber 36 such that the first chamber 36 is in fluid communication with the second chamber 44. The outside wall 40 has a pair of apertures 46 extending into the second chamber 44 and the outside wall 40 has a recessed section 48 adjacent to the distal end 42.

The outside wall 40 corresponding to the recessed section 48 is threaded. The first end 16 of the handle 14 insertably receives the distal end 42 of the shaft 38 having the recessed section 48 threadably engaging the handle 14. In this way the scoop 22 is removably retained on the handle 14. Each of the apertures 46 passes air into the first 36 and second 44 chambers when the shaft 38 is coupled to the handle 14.

A heating unit 50 is provided and the heating unit 50 is coupled to the scooper 12 such that the heating unit 50 is in thermal communication with the scooper 12. The heating unit 50 is selectively turned on to heat the scooper 12. In this way the scooper 12 melts the ice cream when the ice cream is scooped thereby enhancing scooping the ice cream. The heating unit 50 comprises a cartridge 52 that containing a gaseous fuel such as butane or the like. Moreover, the cartridge 52 may be a disposable butane cartridge or the like.

The cartridge 52 has a valve 54 thereon that is in fluid communication with the cartridge 52 and the valve 54 is selectively urged between an open position and a closed position. The valve 54 releases the gaseous fuel from the cartridge 52 when the valve 54 is urged into the open position. The cartridge 52 is removably inserted into the second end 18 of the handle 14. A lever 56 is movably positioned within the handle 14 and the lever 56 engages the valve 54 when the cartridge 52 is positioned in the handle 14.

A first switch 58 is slidably coupled to the outer wall 20 of the handle 14 and the first switch 58 is selectively manipulated. The first switch 58 is in mechanical communication with the lever 56. Thus, the lever 56 urges the valve 54 between the open and closed positions when the first switch 58 is manipulated. Additionally, the first switch 58 urges the valve 54 between a maximum flow rate and a minimum flow rate. In this way the rate of gaseous fuel released from the cartridge 52 may be adjusted.

A sleeve 60 is provided that has a primary end 62 and a secondary end 64. The sleeve 60 is slidably inserted into the second chamber 44 in the handle 14 before the shaft 38 is coupled to the handle 14 having the secondary end 64 surrounding the valve 54. A screen 66 is provided and the screen 66 coupled to the primary end 62 of the sleeve 60. The screen 66 inhibits debris from passing therethrough and potentially clogging the valve 54.

An igniter 68 is positioned within the handle and the igniter 68 selectively generating a spark to ignite the gaseous fuel to heat the first 36 and second 44 chambers. Each of the apertures 46 in the shaft 38 is configured to pass air therethrough to facilitate combustion of the gaseous fuel. A second switch 70 is slidably coupled to the outer wall 20 of the handle 14 wherein the second switch 70 is selectively manipulated. The second switch 70 is in mechanical communication with the igniter 68 such that the igniter 68 generates the spark when the second switch 70 is manipulated. A cap 72 has a first wall 74 and a perimeter wall 76 extending away therefrom and the perimeter wall 76 is continuous. The perimeter wall 76 insertably receives the second end 18 of the handle 17 having the perimeter wall 72 threadably engaging the outer wall 20 of the handle 17. In this way the cap 68 retains the cartridge 52 in the handle 14.

In use, the cap 68 is removed from the handle 14 and the cartridge 52 is inserted into the handle 14. The cap 68 is positioned on the handle 14 to retain the cartridge 52 in the handle 14 and the first switch 58 is selectively manipulated to urge the valve 54 into the open position. The second switch 70 is selectively manipulated to ignite the gaseous fuel thereby heating the scoop 22. In this way the scoop 22 melts the ice cream when the ice cream is scooped thereby enhancing scooping the ice cream. The cartridge 52 is replaced when the gaseous fuel in the cartridge 52 is depleted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated scoop assembly being configured to scoop ice cream, said assembly comprising:
a scooper being configured to be manipulated thereby facilitating said scooper to scoop ice cream; and
a heating unit being coupled to said scooper such that said heating unit is in thermal communication with said scooper, said heating unit being selectively turned on to heat said scooper wherein said scooper is configured to melt the ice cream when the ice cream is scooped thereby enhancing scooping the ice cream.

2. The assembly according to claim 1, wherein said scooper comprises a handle has a first end, a second end and an outer wall extending therebetween, each of said first and second ends being open, said handle being substantially hollow, said outer wall being threaded adjacent to said second end.

3. The assembly according to claim 2, wherein a scoop has an outer wall, said outer wall has a first surface, a second surface and a peripheral edge extending therebetween, each of said first and second surfaces being concavely arcuate such that said scoop has a spherical shape has said peripheral edge defining an opening into said spherical shape wherein said peripheral edge is configured to urge the ice cream into said scoop.

4. The assembly according to claim 3, wherein said peripheral edge has a top section and a bottom section, said peripheral edge curving rearwardly between said top and bottom sections such that said opening defines a hyperbolic parabloid.

5. The assembly according to claim 3, further comprising said scoop has a first chamber between said first surface and said second surface.

6. The assembly according to claim 5, further comprising a shaft extending downwardly from said second surface of said scoop, said shaft has an outside wall and a distal end with respect to said scoop, said distal end has a second chamber extending toward said scoop, said second chamber intersecting said first chamber such that said first chamber is in fluid communication with said second chamber, said outside wall has a pair of apertures extending into said second chamber.

7. The assembly according to claim 6, wherein said outside wall has a recessed section adjacent to said distal end, said outside wall corresponding to said recessed section being threaded, said first end of said handle insertably receiving said distal end of said shaft has said recessed section threadably engaging said handle to removably retain said scoop on said handle, each of said apertures being configured to pass air into said first and second chambers when said shaft is coupled to said handle.

8. The assembly according to claim 1, wherein said heating unit comprises a cartridge containing a gaseous fuel, said cartridge has a valve thereon being in fluid communication with said cartridge, said valve being selectively urged between an open position and a closed position, said valve releasing said gaseous fuel from said cartridge when said valve is urged into said open position, said cartridge being removably inserted into said second end of said handle.

9. The assembly according to claim 8, further comprising a lever being movably positioned within said handle, said lever engaging said valve when said cartridge is positioned in said handle.

10. The assembly according to claim 9, further comprising a first switch being slidably coupled to said outer wall of said handle wherein said first switch is configured to be manipulated, said first switch being in mechanical communication with said lever, said lever urging said valve between said open and closed positions when said first switch is manipulated.

11. The assembly according to claim 8, further comprising:
a handle has a second chamber; and
a sleeve has a primary end and a secondary end, said sleeve being slidably inserted into said second chamber in said handle before said shaft is coupled to said handle has said secondary end surrounding said valve.

12. The assembly according to claim 11, further comprising a screen being coupled to said primary end of said sleeve wherein said screen is configured to inhibit debris from passing therethrough.

13. The assembly according to claim 8, further comprising:
a scoop has a first chamber;
a shaft has a plurality of apertures;
a handle has a second chamber; and
an igniter being positioned within said handle, said igniter selectively generating a spark to ignite said gaseous fuel such that said ignited gaseous fuel heats said first and second chambers, each of said apertures in said shaft being configured to pass air therethrough to facilitate combustion of said gaseous fuel.

14. The assembly according to claim 13, further comprising a second switch being slidably coupled to said outer wall of said handle wherein said second switch is configured to be manipulated, said second switch being in mechanical communication with said igniter such that said igniter generates said spark when said second switch is manipulated.

15. The assembly according to claim 2, further comprising:
a cartridge being positioned in said handle′ and
a cap has a first wall and a perimeter wall extending away therefrom, said perimeter wall being continuous, said perimeter wall insertably receiving said second end of said handle has said perimeter wall threadably engaging said outer wall of said handle such that said cap retains said cartridge in said handle.

16. A heated scoop assembly being configured to scoop ice cream, said assembly comprising:
a scooper being configured to be manipulated thereby facilitating said scooper to scoop ice cream, said scooper comprising:
a handle has a first end, a second end and an outer wall extending therebetween, each of said first and second ends being open, said handle being substantially hollow, said outer wall being threaded adjacent to said second end,
a scoop has an outer wall, said outer wall has a first surface, a second surface and a peripheral edge extending therebetween, each of said first and second surfaces being concavely arcuate such that said scoop has a spherical shape has said peripheral edge defining an opening into said spherical shape wherein said peripheral edge is configured to urge the ice cream into said scoop, said peripheral edge has a top section and a bottom section, said peripheral edge curving rearwardly between said top and bottom sections such that said opening defines a hyperbolic parabloid, said scoop has a first chamber between said first surface and said second surface, and
a shaft extending downwardly from said second surface of said scoop, said shaft has an outside wall and a distal end with respect to said scoop, said distal end has a second chamber extending toward said scoop, said second chamber intersecting said first chamber such that said first chamber is in fluid communication with said second chamber, said outside wall has a pair of apertures extending into said second chamber, said outside wall has a recessed section adjacent to said distal end, said outside wall corresponding to said recessed section being threaded, said first end of said handle insertably receiving said distal end of said shaft has said recessed section threadably engaging said handle to removably retain said scoop on said handle, each of said apertures being configured to pass air into said first and second chambers when said shaft is coupled to said handle; and
a heating unit being coupled to said scooper such that said heating unit is in thermal communication with said scooper, said heating unit being selectively turned on to heat said scooper wherein said scooper is configured to melt the ice cream when the ice cream is scooped thereby enhancing scooping the ice cream, said heating unit comprising:
a cartridge containing a gaseous fuel, said cartridge has a valve thereon being in fluid communication with said cartridge, said valve being selectively urged between an open position and a closed position, said valve releasing said gaseous fuel from said cartridge when said valve is urged into said open position, said cartridge being removably inserted into said second end of said handle,
a lever being movably positioned within said handle, said lever engaging said valve when said cartridge is positioned in said handle,
a first switch being slidably coupled to said outer wall of said handle wherein said first switch is configured to be manipulated, said first switch being in mechanical communication with said lever, said lever urging said valve between said open and closed positions when said first switch is manipulated,
a sleeve has a primary end and a secondary end, said sleeve being slidably inserted into said second chamber in said handle before said shaft is coupled to said handle has said secondary end surrounding said valve,
a screen being coupled to said primary end of said sleeve wherein said screen is configured to inhibit debris from passing therethrough,
an igniter being positioned within said handle, said igniter selectively generating a spark to ignite said gaseous fuel such that said ignited gaseous fuel heats said first and second chambers, each of said apertures in said shaft being configured to pass air therethrough to facilitate combustion of said gaseous fuel,
a second switch being slidably coupled to said outer wall of said handle wherein said second switch is configured to be manipulated, said second switch being in mechanical communication with said igniter such that said igniter generates said spark when said second switch is manipulated, and
a cap has a first wall and a perimeter wall extending away therefrom, said perimeter wall being continuous, said perimeter wall insertably receiving said second end of said handle has said perimeter wall threadably engaging said outer wall of said handle such that said cap retains said cartridge in said handle.
